(19) United States
(12) Patent Application Publication
(10) Pub. No.: US 2009/0040906 A1
(43) Pub. Date: Feb. 12, 2009

(54) SIL NEAR-FIELD SYSTEM

(75) Inventors: Tao Hong, Suwon-si (KR); Tae-Kyung Kim, Seoul (KR); Jin-Kyung Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/033,287

(22) Filed: Feb. 19, 2008

(30) Foreign Application Priority Data
Aug. 10, 2007 (KR) 2007-80843

(51) Int. Cl. G11B 7/00; G02B 3/00; G02B 5/30; G02B 3/02

(52) U.S. Cl. 369/112.23; 359/738; 359/485; 359/709

(57) ABSTRACT

A solid immersion lens (SIL) near-field system including: a radially polarized beam generator to generate a radially polarized beam; an SIL; an objective lens to focus the radially polarized beam on a bottom surface of the SIL; and a mask to shield a center portion of the radially polarized beam, the center portion being about an optical axis of the radially polarized beam.

### CROSS-REFERENCE TO RELATED APPLICATIONS

This application claims the benefit of Korean Patent Application No. 2007-80843, filed on Aug. 10, 2007, in the Korean Intellectual Property Office, the disclosure of which is incorporated herein by reference.

### BACKGROUND OF THE INVENTION

1. Field of the Invention

Aspects of the present invention relate to a solid immersion lens (SIL) near-field system, and more particularly, to an SIL near-field system having a long working distance so as to sufficiently control a gap to prevent the SIL and a disc surface from colliding with each other in the near-field system.

2. Description of the Related Art

In order to increase a storage capacity of a recording medium, research to develop multilayer recording media using a laser beam of a short wavelength and an objective lens having a high numerical aperture (NA) is being performed. As a result of such research, Blu-ray discs, having a storage capacity of 25 GB for each layer in its multilayer structure, have been developed using a blue-violet laser diode and an objective lens having an NA of 0.85. A Blu-ray disc can be used to record two hours of high-definition television or thirteen hours of standard-definition television. However, such a conventional optical storage method cannot satisfy future storage capacity requirements. Therefore, a new kind of storage method is required.

As such, a conventional near-field storage using a solid immersion lens (SIL) has been developed to increase the storage capacity using characteristics of a near-field optical system. FIG. 1 schematically shows a hemispherical SIL 3 with an objective lens 5, and FIG. 2 schematically shows a super-hemispherical SIL 3′ with an objective lens 5.

Referring to FIGS. 1 and 2, a light incident on the objective lens 5 is focused on a bottom surface 3a of the hemispherical SIL 3 or the super-hemispherical SIL 3′, which has a high refraction index, by the objective lens 5. Further, a small focus spot, capable of reducing a size of a recording pit, can be formed on the bottom surface 3a of the hemispherical SIL 3 or the super-hemispherical SIL 3′. An air gap between the bottom surface 3a of the hemispherical SIL 3 or the super-hemispherical SIL 3′ and a disc 1 should be maintained within a range of 20 to 30 nm in order to prevent the small focus spot from spreading.

In general, the SIL can be classified into two types, that is, the hemispherical type and the super-hemispherical type. A thickness of the super-hemispherical SIL is (1+1/nSIL)r (where, r is a radius of the sphere, and nSIL is a refractive index of the material forming the SIL). In a system using the hemispherical SIL, an effective NA (NAeff) can be calculated as defined by the following Equation 1:

NAeff=NAobj×nSIL (Equation 1)

In a system using the super-hemispherical SIL, an effective NA (NAeff) can be calculated as defined by the following Equation 2:

NAeff=NAobj×n2SIL (Equation 2)

In Equations 1 and 2, NAobj is the NA of the objective lens, and nSIL and n2SIL are the refractive indexes of the materials forming the respective SILs.

In the conventional near-field optical storage system including the SIL, the air gap between the disc and the SIL is very small, that is, about 20 to 30 nm, so as to prevent the small focus spot from being spread. FIG. 3 is a graph showing a size change of the focus spot according to an increase in the air gap. As shown in FIG. 3, the size of the spot rapidly increases with the increase in the air gap. Therefore, a stable gap servo is required in consideration of the small air gap so that the disc and the SIL do not collide with each other in the near-field system. The small air gap also causes a strict tilt margin of the disc in order to prevent the collision from occurring. The small air gap, that is, a small working distance, of the near-field system is limited in terms of further development of the near-field system having the SIL.

### SUMMARY OF THE INVENTION

Aspects of the present invention provide an SIL near-field system having a longer working distance by using an incident light that is radially polarized in order to solve a problem caused by the small working distance in the SIL near-field system.

According to an aspect of the present invention, there is provided a solid immersion lens (SIL) near-field system including: a radially polarized beam generator to generate a radially polarized beam; an SIL; an objective lens to focus the radially polarized beam on a bottom surface of the SIL; and a mask to shield a center portion of the radially polarized beam, the center portion being about an optical axis of the radially polarized beam.

According to an aspect of the present invention, the radially polarized beam generator may include: a light source to emit a linearly polarized beam of a predetermined wavelength; and a radial polarization converter to convert the linear polarization of the incident beam into a radial polarization.

According to an aspect of the present invention, the radial polarization converter may be a diffractive optical element or a liquid crystal element to convert the polarization status of the incident beam from the linear polarization to a radial polarization.

According to an aspect of the present invention, the radially polarized beam generator may further include a collimating lens to collimate the beam emitted from the light source.

According to an aspect of the present invention, the system may further include: a hollow beam generator to generate a hollow incident beam in order to reduce a light loss caused by the shielding operation of the mask.

According to an aspect of the present invention, the hollow beam generator may include: a first conical lens disposed so that the radially polarized beam emitted from the radially polarized beam generator can be incident upon a flat incident surface of the first conical lens; and a second conical lens disposed so that the radially polarized beam incident from the first conical lens can exit through a flat exit surface of the second conical lens.

According to an aspect of the present invention, a minimum diameter of the mask (Dmask) may be calculated as Dmask=2×EFLobj×sin(1/nSIL), where a focal length of the objective lens is EFLobj and a refractive index the SIL is nSIL.

According to an aspect of the present invention, the system may further include: a magnifying lens to adjust the focal point of the near-field system.

According to an aspect of the present invention, the SIL may be formed as a hemisphere, a super-hemisphere, a truncated hemisphere, an oval, or an aspherical shape.

According to an aspect of the present invention, the system may further include: a metal film formed on the bottom surface of the SIL to have a sub-micron opening in a center portion of the metal film to restrain side lobes in an intensity profile of the focus spot.

According to an aspect of the present invention, the near-field system may be used for optical storage, optical lithography, and optical trapping of a particle.

According to an aspect of the present invention, the near-field system may irradiate the beam focused by the objective lens and the SIL onto a disc, and the near-field system used for optical recording/reproducing may further include: a first photodetector to receive the beam reflected by the disc to detect an information signal or an error signal; and a first optical path changer to change an optical path of the radially polarized beam that is incident thereupon.

According to an aspect of the present invention, the system may further include: a second photodetector to detect signals to control a gap servo; and a second optical path changer disposed between the radially polarized beam generator and the first optical path changer or between the first optical path changer and the objective lens to change an optical path of the radially polarized beam that is incident thereon so that a portion of the beam reflected by the disc can proceed toward the second photodetector.

According to an aspect of the present invention, the system may further include: a magnifying lens to adjust the focus of the radially polarized beam with respect to the disc, the magnifying lens being disposed between the radially polarized beam generator and the objective lens.

Aspects of the present invention provide an SIL near-field system having a long working distance by using a radially polarized incident beam. In the SIL near-field system according to aspects of the present invention, the working distance can be increased to 100 nm or longer. By comparing the SIL near-field system according to aspects of the present invention with the conventional SIL near-field system, a gap servo and a tilt margin according to aspects of the present invention can be relaxed, and a scratch and a collision between an SIL and a disc can be prevented, and thus, the disc and the SIL can be protected.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram showing a hemispherical SIL with an objective lens;

FIG. 2 is a schematic diagram showing a super-hemispherical SIL with an objective lens;

FIG. 3 is a graph showing a relation between an air gap and a spot size in an SIL near-field system;

FIG. 4 is a diagram of a linearly polarized beam;

FIG. 5 is a diagram of a circularly polarized beam;

FIG. 6 is a diagram of a radially polarized beam;

FIG. 7A is a schematic diagram of an SIL near-field system according to an embodiment of the present invention;

FIG. 7B is a schematic diagram showing an example of a structure of a radially polarized beam generator shown in FIG. 7A;

FIG. 8 schematically shows a simulation model including only an SIL and an air gap to obtain an optical field distribution of an SIL near-field system;

FIG. 9 is an image showing a distribution of an optical field intensity calculated by the simulation model of FIG. 8;

FIG. 10 is a graph of a section of a field distribution for an air gap of 0 nm;

FIG. 11 is a graph of a section of a field distribution for an air gap of 100 nm;

FIG. 12 is a simulation model including an SIL, an air gap, and a disc to obtain an optical field distribution;

FIG. 13 is an image showing a distribution of an optical field intensity that is calculated using the simulation model of FIG. 12 for an air gap of 30 nm;

FIG. 14 is an image showing a distribution of an optical field intensity that is calculated using the simulation model of FIG. 12 for an air gap of 100 nm;

FIG. 15 is a graph showing normalized spot profiles for an air gap of 30 nm and 100 nm;

FIG. 16 is a graph showing spot profiles for an air gap of 30 nm and an air gap of 100 nm;

FIG. 17 is a diagram showing an SIL having a sub-micro opening on a center portion, on a bottom surface of the SIL; and

FIG. 18 is a schematic diagram of an SIL near-field system having a long working distance by using a radially polarized incident beam for optical recording/reproducing, according to an embodiment of the present invention.

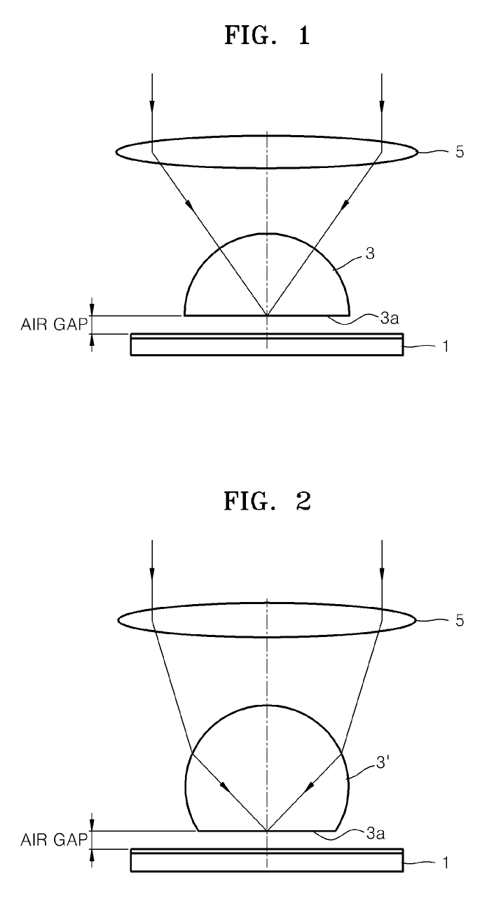

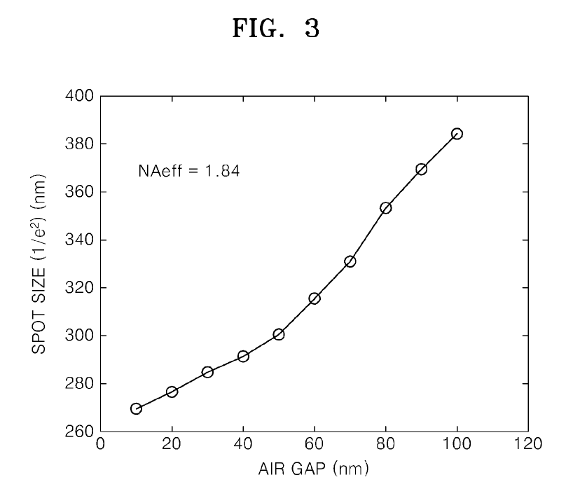

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

A near-field recording using an SIL can realize a high recording density using a lens having a high effective numerical aperture (NA). However, an air gap existing between the SIL and a recording medium must be maintained within a range of 20 to 30 nm due to a rapid increase in a spot size and a decay of an evanescent wave, which results in the need for a strict gap servo and a tight tilt margin.

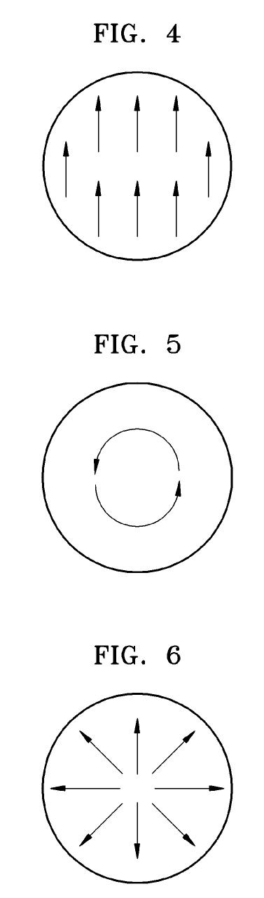

In a general near-field system having the SIL, a linearly polarized beam or a circularly polarized beam is used as an incident beam. FIG. 4 shows the linearly polarized beam, and FIG. 5 shows the circularly polarized beam. The linear polarization and the circular polarization, shown in FIGS. 4 and 5, are homogeneous polarization states because electric field vectors at each point in a section of the incident beam are equal in state to each other. In the linearly polarized beam, the electric field vector has one direction, and in the circularly polarized beam, the electric field vector rotates.

A radial polarization is different from the above-described types of polarization, that is, an electric field vector at each point of the incident beam is in a radial direction as shown in FIG. 6. FIG. 6 shows the radially polarized beam.

When the radially polarized beam is focused onto a lens having a high NA, a sharp focus spot can be generated. The size of the focus spot generated from the radially polarized beam is relatively smaller than that formed by the linearly polarized beam or the circularly polarized beam. Moreover, a longitudinal component of a focus field with respect to the radially polarized beam has a non-diffraction property that allows a constant spot size to be maintained along a propagation direction at a certain distance. Therefore, the size of the focus spot can be constantly maintained within a certain distance range, and thus, the radially polarized beam can increase a working distance of the SIL in near-field recording.

Here, the non-diffraction property of the longitudinal component can be further strengthened by shielding the central portion of the beam incident on the collimating lens with the low NA from the portion of the beam incident on the collimating lens with the high NA. Therefore, in the near-field system including the SIL according to aspects of the present invention, a mask may be used in order to shield the incident beam having the low NA so that the longitudinal component is strengthened. In addition, a pair of conical lenses disposed to make a hollow beam may be used so as to reduce a light loss caused by the shielding of the mask.

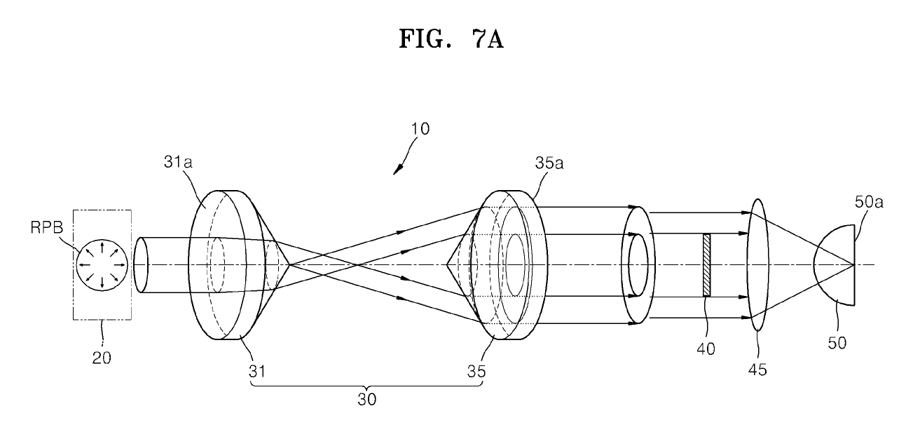

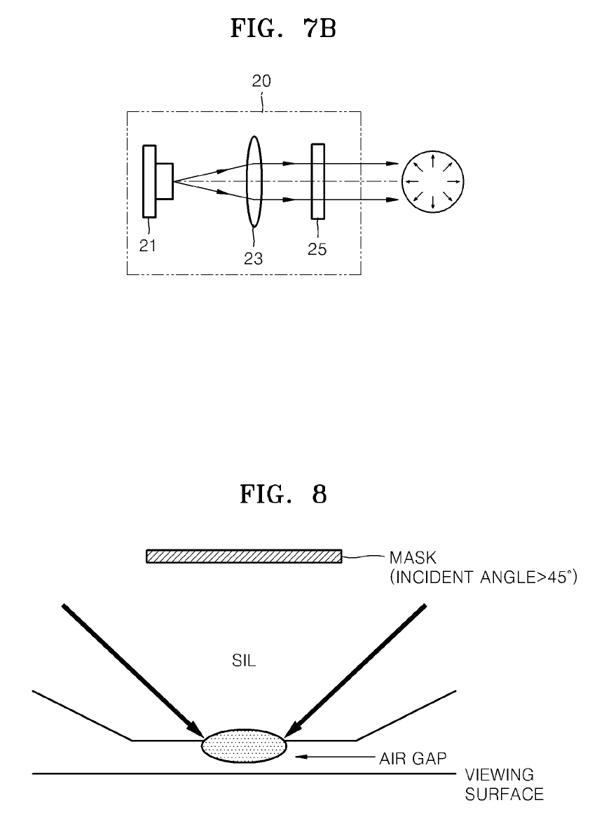

FIG. 7A is a schematic diagram of an SIL near-field system 10 according to an embodiment of the present invention, and FIG. 7B is a schematic diagram showing an example of a structure of a radially polarized beam generator 20 shown in FIG. 7A. Referring to FIGS. 7A and 7B, the SIL near-field system 10 according to aspects of the present invention includes the radially polarized beam generator 20 generating a radially polarized beam (RPB), a condensing lens to condense the incident radially polarized beam, for example, an objective lens 45, and an SIL 50 located on a focusing point of the objective lens 45. The SIL near-field system according to aspects of the present invention can further include a mask 40 that blocks a center portion of the RPB so as to increase the longitudinal component of the focus field of the RPB. In addition, the SIL near-field system 10 may further include a hollow beam generator 30 so as to reduce the light loss that is caused by the mask 40, which blocks the center portion of the RPB before the RPB is focused on a bottom surface 50a of the SIL 50 by the objective lens 45.

Referring to FIG. 7B, the radially polarized beam generator 20 includes a light source 21 emitting a laser beam of a predetermined wavelength, for example, a blue laser beam having a wavelength of approximately 405 nm, and a radial polarization converter 25 to convert the polarization direction of the beam emitted from the light source 21 into a radial polarization. The radially polarized beam generator 20 can further include a collimating lens 23 that collimates the beam emitted from the light source 21. The collimating lens 23 can be disposed between the light source 21 and the radial polarization converter 25.

The light source 21 that emits the laser beam can emit a linearly polarized beam. Therefore, a diffractive optical element or a liquid crystal element to convert the polarization of the incident light into the radial polarization can be used as the radial polarization converter 25. A radial polarization converter 25 formed of a diffractive optical element is disclosed in Radially and Azimuthally Polarized Beams Generated by Space-Variant Dielectric Sub-Wavelength Gratings, Ze'ev Bomzon, et al., OPTICS LETTERS Vol. 27, No. 5, published on Mar. 1, 2002. A radial polarization converter 25 formed of a liquid crystal element is disclosed in Linearly Polarized Light with Axial Symmetry Generated by Liquid-Crystal Polarization Converters, M. Stalder, et al., OPTICS LETTERS Vol. 21, No. 23, published on Dec. 1, 1996.

Referring back to FIG. 7A, the mask 40 shields the incident beam having the low NA so as to strengthen the longitudinal component of the near-field that is focused on the bottom surface 50a of the SIL 50, and is disposed to block the center portion of the incident beam, the center portion being about an optical axis of the radially polarized beam. The mask 40 can be disposed between the radially polarized beam generator 20 and the objective lens 45.

A minimum diameter (Dmask) of the mask 40 can be set as Dmask=2×EFLobj×sin(1/nSIL), when it is assumed that a focal length of the objective lens 45 is EFLobj and a refractive index of a material forming the SIL 50 is nSIL. A maximum diameter of the mask 40 should be less than an entrance pupil diameter (EPD) of the objective lens 45.

The hollow beam generator 30 prevents light loss that is caused by the shielding of the incident beam near the optical axis by the mask 40 and may be disposed between the radially polarized beam generator 20 and the mask 40. The hollow beam generator 30 includes a first conical lens 31 and a second conical lens 35 that are disposed to generate hollow incident beams. The first conical lens 31 is disposed so that a flat surface facing the radially polarized beam generator 20 is an incident surface 31 a into which the RPB emitted from the radially polarized beam generator 20 is incident as a parallel beam. The second conical lens 35 is disposed so that a flat surface becomes an exit surface 35a from which the beam that is hollowed by passing through the first conical lens 31 as a parallel beam exits.

Therefore, when the parallel beam is incident to the first conical lens 31, the beam passing through the first and second conical lenses 31 and 35 becomes a hollow parallel beam. A diameter of hollow circle at a center of the hollow beam formed by the first and second conical lenses 31 and 35 may be the same as or similar to that of the mask 40 in order to minimize the light loss.

The objective lens 45 focuses the incident RPB onto the bottom surface 50a of the SIL 50. The SIL 50 can be a hemispherical type, a super-hemispherical type, a truncated hemispherical type, an oval type, or an aspherical type.

The SIL near-field system 10 having the above structure according to the present embodiment can have a working distance that is longer than that of the conventional near-field system by using the incident RPB. The SIL near-field system 10 having the long working distance that is longer than that of the conventional near-field system can be applied to various optical systems requiring a small light spot and a long working distance. For example, the SIL near-field system 10 can be used as an optical storage system for Blu-ray discs (BDs) or high definition digital versatile discs (HDDVDs), in optical lithography, and in optical trapping of a particle.

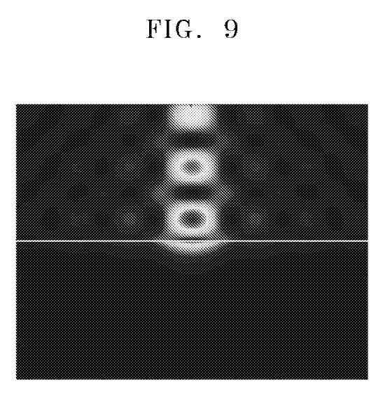

FIG. 8 schematically shows a simulation model including only an SIL and an air gap to obtain an optical field distribution of a near-field system. In FIG. 8, a mask is used to strengthen the longitudinal component, and the size of the mask is formed to shield light of the beam having an incident angle less than 45°.

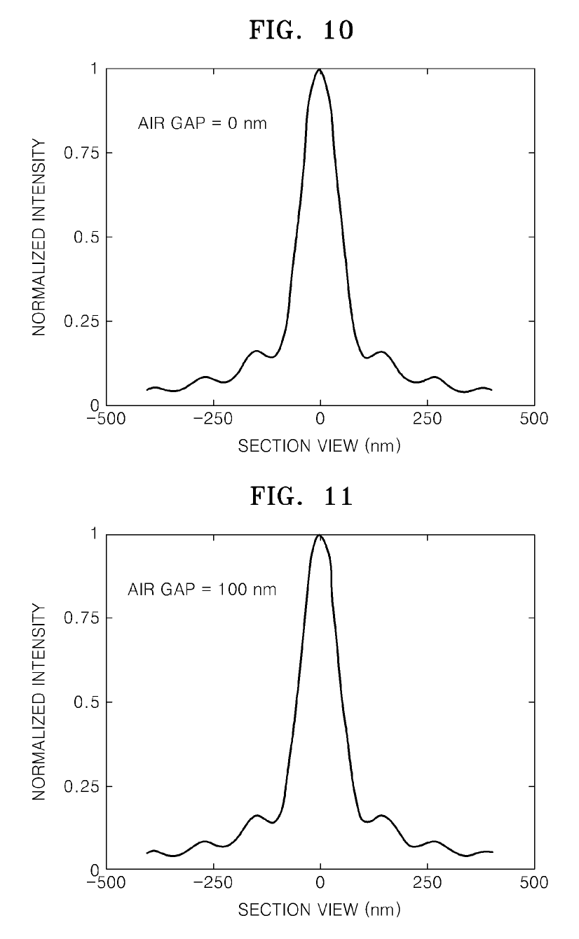

FIG. 9 is an image showing an intensity distribution of the optical field that is calculated using the simulation model of FIG. 8. FIG. 10 shows a distribution of a normalized intensity on an interface between the SIL and the air (air gap=0 nm). FIG. 11 shows a distribution of a normalized intensity at a position 100 nm apart from an interface between the SIL and the air (air gap=100 nm).

As shown in FIGS. 10 and 11, a spot profile can be maintained with less distortion within at least a range of a 100 nm air gap, and the size of the spot is constant. As such, the spot size and the spot profile can be constantly maintained so that the working distance of the SIL can be increased by using the radially polarized incident beam.

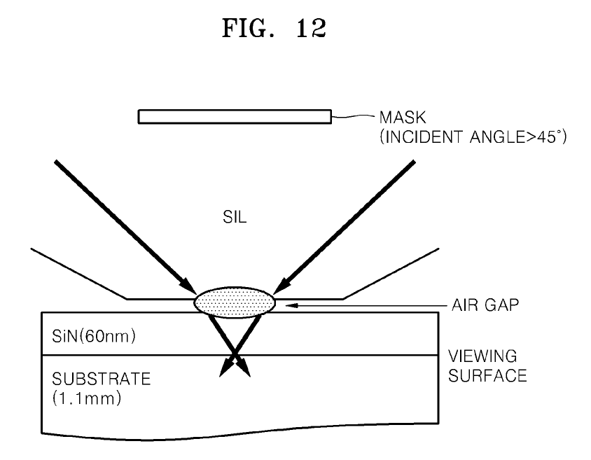

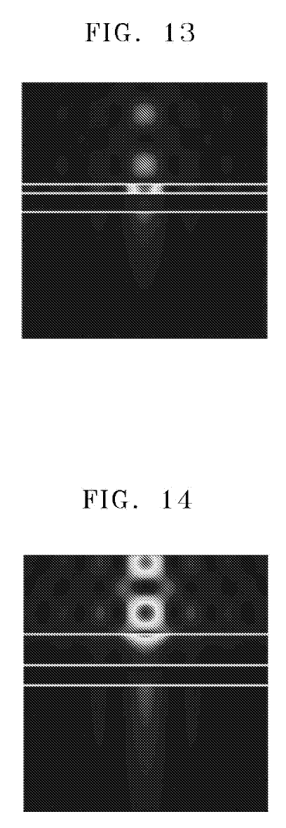

FIG. 12 shows a simulation model that includes a disc having a SiN cover layer of a thickness of 60 nm is added to the simulation model shown in FIG. 8 in order to check interrelations with the disc.

The intensity distributions of the simulation model of FIG. 12 for when the air gap is 30 nm and for when the air gap is 100 nm are calculated and respectively shown in FIGS. 13 and 14. As shown in FIGS. 13 and 14, the limited intensity distributions can be formed even though the disc is used.

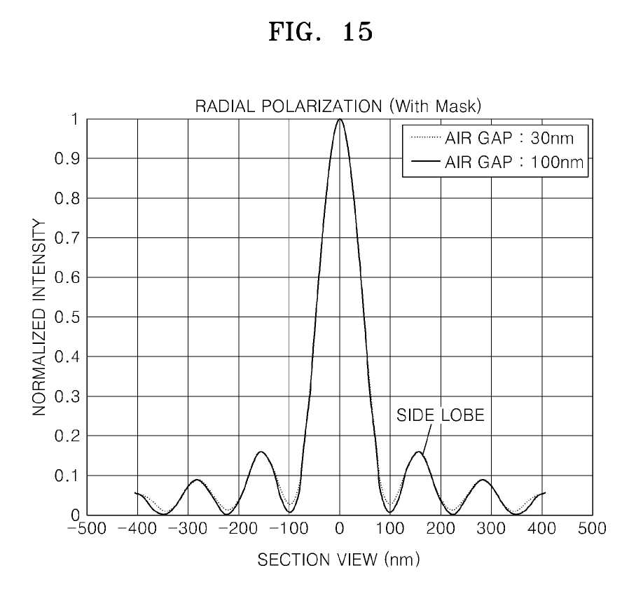

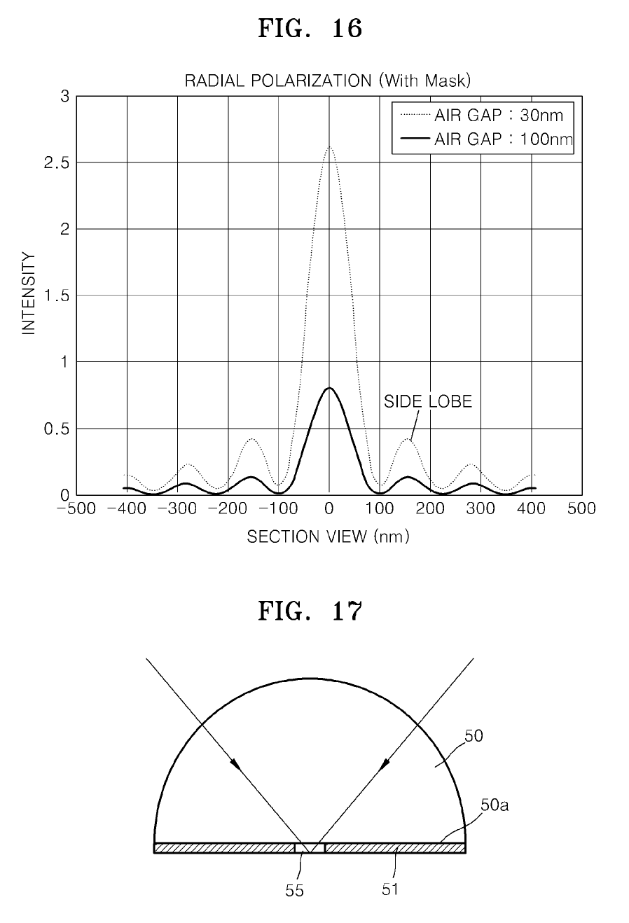

FIG. 15 shows distributions of normalized intensities at positions in which the bottom surface 50a of the SIL 50 is 30 nm and 100 nm from the disc (i.e., when the air gap is 30 nm and is 100 nm). FIG. 16 shows the intensity distributions at positions in which the bottom surface 50a of the SIL 50 is 30 nm and 100 nm from the disc (that is, when the air gap is 30 nm and is 100 nm).

The spot profiles when the air gap is 30 nm and 100 nm are similar to each other as shown in FIG. 15. However, the intensity peak when the air gap is 100 nm is one-third the intensity peak when the air gap is 30 nm, as shown in FIG. 16.

As shown in FIG. 15, since the spot size does not change when the air gap increases from 30 nm to 100 nm, the working distance of the SIL can increase to 100 nm in a case where the radially polarized incident beam is used. Accordingly, the gap servo and the tilt margin can be relaxed while preventing the collision of the SIL with the disc. Although the intensity peak is reduced three times, such reduction in the intensity can be reinforced by increasing the power of laser beam that is used. Due to the intensity reduction, there is a tradeoff relationship between the working distance increase and the intensity reduction.

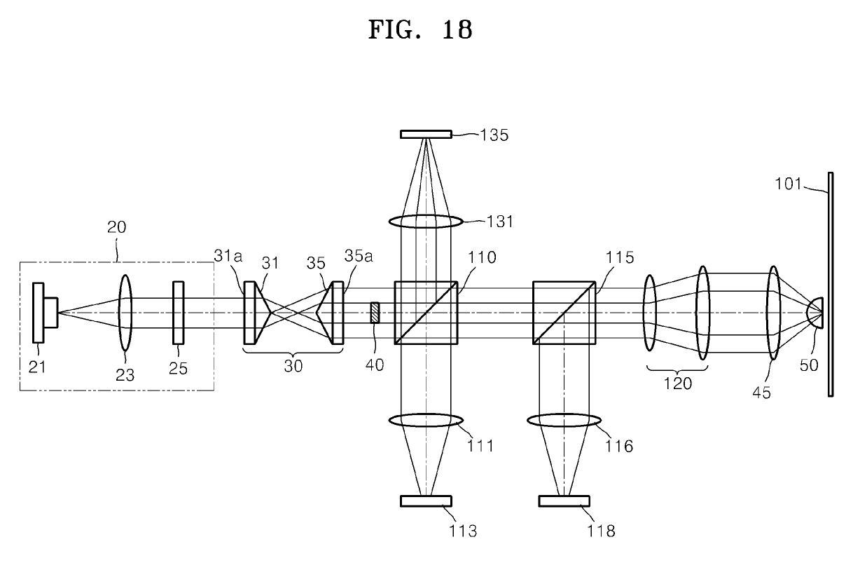

In the focus spot intensity profile, there are relatively large side lobes that can affect signal qualities in terms of recording and reproducing data, as shown in FIGS. 15 and 16. Therefore, the SIL near-field system 10 shown in FIGS. 7A and 7B according to the present embodiment may use an evanescent wave apodization unit so as to restrain the side lobes from affecting the signal quality. For example, as shown in FIG. 17, a metal film 51 can be coated on the bottom surface 50a of the SIL 50 such that a sub-micron opening 55 can be formed at a center portion of the SIL 50. Here, if a shape and the size of the opening 55 are optimized and an appropriate material for forming the metal film 51 is selected, the longitudinal component in the optical field can be reinforced more, and a transversal component in the optical field can be restricted thereby restricting the effect of the side lobes on the signal quality.

FIG. 18 is a schematic diagram of a structure of an SIL near-field system 100 for optical recording/reproducing, according to an embodiment of the present invention as an example of an optical system adopting the SIL near-field system 10 shown in FIGS. 7A and 7B. However, aspects of the present invention are not limited to the structure illustrated in FIG. 18, and thus, the optical structure can be variously modified. The same components as those of FIGS. 7A and 7B are denoted by the same reference numerals, and thus, descriptions for these components will be omitted.

Referring to FIG. 18, the SIL near-field system 100 for optical recording/reproducing includes the radially polarized beam generator 20, the objective lens 45, the SIL 50, a first photodetector 118 to receive a beam reflected by a disc 101 so as to detect an information signal or an error signal, and a first optical path changer 115 to direct an optical path of the incident radially polarized beam reflected by the disc 101 to the first photodetector 118. The SIL near-field system 100 for optical recording/reproducing can further include the mask 40 to shield the incident beam having a low NA, and thus, strengthen the longitudinal component of the optical field. In addition, the SIL near-field system 100 for optical recording/reproducing can further include the hollow beam generator 30 to reduce an optical loss caused by the shielding operation of the mask 40. The hollow beam generator 30 can include the first and second conical lenses 31 and 35 as described above. In addition, the SIL near-field system 100 for optical recording/reproducing can further include a second optical path changer 110 and a second photodetector 113 to detect a signal that controls the gap servo. The second optical path changer 110 directs a portion of the beam from the hollow beam generator 30 to the monitor photodetector 135 and to the first optical path changer 115. Further, the second optical path changer 110 directs a portion of the beam from the disc 101 to the second photodetector 113. In addition, the SIL near-field system 100 for optical recording/reproducing can further include a magnifying lens 120 to adjust a focal point.

As described with reference to FIG. 7B, the radially polarized beam generator 20 can include the light source 21 and the radial polarization converter 25. In addition, the radially polarized beam generator 20 can further include the collimating lens 23 between the light source 21 and the radial polarization converter 25. The radial polarization converter 25 converts the polarization of the incident linearly polarized beam into the radial polarization. The light source 21 can include a laser diode that emits a linearly polarized beam within a predetermined wavelength range. For example, the light source 21 can emit the beam in the blue wavelength range, that is, the beam having a wavelength of about 405 nm that satisfies the standards for the HD DVDs and BDs. Otherwise, the light source 21 can emit a beam of different wavelength.

A power of the light source 21 can be monitored by a monitor photodetector 135. The beam emitted from the light source 21 passes through the collimating lens 23 that changes a diverging beam into a parallel beam. The parallel beam then passes through the radial polarization converter 25, the first and second conical lenses 31 and 35, the mask 40, the second and first optical path changers 110 and 115, and the magnifying lens 120, and then, is incident to the objective lens 45.

The first and second conical lenses 31 and 35 change the beam proceeding from the radial polarization converter 25 into the hollow beam in order to avoid the light loss caused by the shielding operation of the mask 40.

The first optical path changer 115 changes the optical path of the incident radially polarized beam such that the radially polarized beam incident from the radial polarization beam generator 20 proceeds toward the objective lens 45, and a portion of the radially polarized beam reflected by the disc 101 passes through the SIL 50 and the objective lens 45 to proceed toward the first photodetector 118.

The second optical path changer 110 changes the optical path of the radially polarized beam so that the radially polarized beam incident from the radial polarization beam generator 20 proceeds toward the objective lens 45, and a portion of the radially polarized beam reflected by the disc 101 passes through the SIL 50 and the objective lens 45 to proceed toward the second photodetector 113.

A beam splitter can be used as the first or second optical path changers 115 or 110. In FIG. 18, the second optical path changer 110 is disposed between the radially polarized beam generator 20 and the first optical path changer 115; however, the second optical path changer 110 can be disposed between the first optical path changer 115 and the objective lens 45, i.e., the organization of the first and second optical path changers 115 and 110 need not be limited to that as shown in FIG. 18.

Sensor lenses 116 and 111 can be further disposed on the optical path between the first optical path changer 115 and the first photodetector 118 and between the second optical path changer 110 and the second photodetector 113, respectively.

Also, as illustrated in FIG. 18, in which a monitoring photodetector 135 can be disposed so as to detect the beam that is incident from the radially polarized beam generator 20 and partially reflected by the second optical path changer 110. On the optical path between the monitoring photodetector 135 and the second optical path changer 110, a sensor lens 131 can be further disposed. Alternatively, the monitoring photodetector 135 and the sensor lens 113 can be disposed to detect the beam that is incident from the radially polarized beam generator 20 and partially reflected by the first optical path changer 115.

The magnifying lens 120 is used to adjust the focal point of the SIL near-field system 100 for optical recording/reproducing of the present embodiment, and the magnifying lens 120 can be adjusted so that the beam is accurately focused on the bottom surface 50a of the SIL 50.

The objective lens 45 focuses the beam on the bottom surface 50a of the SIL 50. Data can be recorded and/or reproduced onto/from a recording layer of the disc 101 by a near-field coupling of the objective lens 45 and the SIL 50. The objective lens 45 can have a high NA, for example, about 0.77, and can obtain an effective NA of about 1.84 when the refractive index of the SIL 50 material is about 2.38. Due to the non-diffractive property of the longitudinal component in the radial polarization, the profile of the spot formed on the bottom surface 50a of the SIL 50 can be maintained, and the size of the spot can be constant up to an air gap of 100 nm. Thus, the working distance of the SIL 50 can be increased.

In order to restrain the side lobes from being generated in the intensity profile of the focused spot, the metal film 51 having the opening 55 on the center portion of the metal film 51 can be coated on the bottom surface 50a of the SIL 50 as shown in FIG. 17. Hence, the opening 55 may be formed to have a size in sub-micron range. The material forming the metal film 51 and the size and shape of the opening 55 can be selected so as to obtain a sufficient effect to restrain the side lobes from generating.

On the other hand, in FIG. 18, the SIL near-field system 100, for optical recording/reproducing, uses a tracking method using a single beam in order to control a tracking servo. Instead of this example, a grating (not shown) that diffracts the beam emitted from the light source 21 into 0th order and 1st orders can be further included to use the tracking method using three beams.

According to the SIL near-field system 100 for optical recording/reproducing having the above structure, the radially polarized beam incident into the disc 101 is reflected by the disc 101 and is condensed by the SIL 50 and the objective lens 45. After that, the beam passes through the magnifying lens 120, and is partially reflected by the first and second optical path changers 115 and 110. Here, the first photodetector 118 detects an information signal, that is, an RF signal, and the second photodetector 113 detects a gap servo signal which is a signal to maintain the air gap between the SIL 50 and the disc 101 constant.

In the above description, the SIL near-field system 100 using the radially polarized beam according to aspects of the present invention is used to perform the optical recording/reproducing in optical data storage. Further, the SIL near-field system 100 according to aspects of the present invention can be used in optical trapping and optical lithography, etc.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A solid immersion lens (SIL) near-field system, comprising:
a radially polarized beam generator to generate a radially polarized beam;
an SIL;
an objective lens to focus the radially polarized beam on a bottom surface of the SIL; and
a mask to shield a center portion of the radially polarized beam, the center portion being about an optical axis of the radially polarized beam.

2. The system of claim 1, wherein the radially polarized beam generator comprises:
a light source to emit a linearly polarized beam of a predetermined wavelength; and
a radial polarization converter to convert the linear polarization of the incident beam into a radial polarization.

3. The system of claim 2, wherein the radial polarization converter is a diffractive optical element or a liquid crystal element that converts the polarization of the incident beam from the linear polarization to a radial polarization.

4. The system of claim 2, wherein the radially polarized beam generator further includes a collimating lens to collimate the beam emitted from the light source.

5. The system of claim 1, further comprising:
a hollow beam generator disposed between the radially polarized beam generator and the mask to generate a hollow incident beam in order to reduce a light loss caused by the shielding operation of the mask.

6. The system of claim 5, wherein the hollow beam generator comprises:
a first conical lens disposed so that the radially polarized beam emitted from the radially polarized beam generator is incident on a flat surface of the first conical lens; and
a second conical lens disposed so that the radially polarized beam incident from the first conical lens exits through a flat surface of the second conical lens.

7. The system of claim 1, wherein a minimum diameter of the mask (Dmask) is calculated as Dmask=2×EFLobj×sin(1/nSIL), where a focal length of the objective lens is EFLobj and a refractive index of the SIL is nSIL.

8. The system of claim 1, further comprising:
a magnifying lens to adjust the focal point of the near-field system.

9. The system of claim 1, wherein the SIL is a hemisphere, a super-hemisphere, a truncated hemisphere, an oval, or an aspherical shape.

10. The system of claim 1, further comprising:
a metal film formed on the bottom surface of the SIL having a sub-micron opening in a center portion of the metal film to restrain side lobes in an intensity profile of the focus spot.

11. The system of claim 1, wherein the near-field system is used for optical storage, optical lithography, and optical trapping of a particle.

12. The system of claim 1, wherein the near-field system irradiates the beam focused by the objective lens and the SIL onto a disc to record and/or reproduce data on and/or from the disc, and the near-field system used for optical recording and/or reproducing further comprises:
a first photodetector to receive the beam reflected by the disc to detect an information signal or an error signal; and
a first optical path changer to direct an optical path of the radially polarized beam that is incident thereon toward the first photodetector.

13. The system of claim 12, further comprising:
a second photodetector to detect signals for controlling a gap servo; and
a second optical path changer disposed between the radially polarized beam generator and the first optical path changer or between the first optical path changer and the objective lens to direct an optical path of a portion of the radially polarized beam that is incident thereon toward the second photodetector.

14. The system of claim 12, further comprising:
a magnifying lens to adjust the focus of the radially polarized beam with respect to the disc, the magnifying lens being disposed between the radially polarized beam generator and the objective lens.

15. The system of claim 12, wherein the bottom surface of the SIL is about 100 nm from a surface of the disc.

16. An optical recording and/or reproducing apparatus, comprising:
a radially polarized beam generator to generate a radially polarized beam;
a solid immersion lens (SIL) to focus the radially polarized beam on an optical disc;
an objective lens to focus the radially polarized beam on a bottom surface of the SIL;
a mask to shield a center portion of the radially polarized beam, the center portion being about an optical axis of the radially polarized beam;
a first photodetector to receive a beam reflected by the disc to detect an information signal or an error signal; and
a first optical path changer to direct an optical path of at least a first portion of the radially polarized beam reflected by the disc to the first photodetector.

17. The optical recording and/or reproducing apparatus of claim 16, further comprising:
a second photodetector to detect a signal to control a gap servo; and
a second optical path changer to direct a second portion of the radially polarized beam reflected by the disc to the second photodetector.

18. The optical recording and/or reproducing apparatus of claim 17, further comprising:
a third photodetector to detect a power of the radially polarized beam generator,
wherein one of the first and second optical path changers directs a portion of the radially polarized beam from the radially polarized beam generator toward the third photodetector.

19. The optical recording and/or reproducing apparatus of claim 16, further comprising:
a hollow beam generator disposed between the radially polarized beam generator and the mask.

20. The optical recording and/or reproducing apparatus of claim 19, wherein the hollow beam generator comprises:
a first conical lens disposed so that the radially polarized beam from the radially polarized beam generator is incident upon the flat surface of the first conical lens; and
a second conical lens disposed so that the radially polarized beam from the first conical lens exits the flat surface of the second conical lens.

21. The optical recording and/or reproducing apparatus of claim 16, further comprising:
a magnifying lens to adjust the focus of the radially polarized beam with respect to the disc, the magnifying lens being disposed between the radially polarized beam generator and the objective lens.

22. The optical recording and/or reproducing apparatus of claim 16, wherein the bottom surface of the SIL is about 100 nm from a surface of the disc.

23. The optical recording and/or reproducing apparatus of claim 16, further comprising a metal film formed on the bottom surface of the SIL and having a sub-micron opening in a center portion thereof to restrain side lobes in an intensity profile of the focus spot.

24. A solid immersion lens (SIL) near-field system, comprising:
a radially polarized beam generator to generate a radially polarized beam;
an SIL;
an objective lens to focus the radially polarized beam on a bottom surface of the SIL; and
a hollow beam generator disposed between the radially polarized beam generator and the SIL to generate a hollow, radially polarized beam.

25. The solid immersion lens (SIL) near-field system of claim 24, wherein the hollow beam generator comprises:
a first conical lens disposed so that the radially polarized beam from the radially polarized beam generator is incident upon the flat surface of the first conical lens; and
a second conical lens disposed so that the radially polarized beam from the first conical lens exits the flat surface of the second conical lens.

26. The solid immersion lens (SIL) near-field system of claim 24, further comprising:
a mask disposed between the hollow beam generator and the objective lens to shield a center portion of the hollowed, radially polarized beam, the center portion being about an optical axis of the radially polarized beam generator.
